(19) United States
(12) Patent Application Publication
(10) Pub. No.: US 2018/0064080 A1
(43) Pub. Date: Mar. 8, 2018

(54) FISH HOOK HAVING A CLIP

(71) Applicant: Young W. Lee, Perrysburg, OH (US)

(72) Inventor: Young W. Lee, Perrysburg, OH (US)

(21) Appl. No.: 15/697,383

(22) Filed: Sep. 6, 2017

Related U.S. Application Data
(60) Provisional application No. 62/384,101, filed on Sep. 6, 2016.

(51) Int. Cl. A01K 83/06

(52) U.S. Cl. CPC A01K 83/06

(57) ABSTRACT

A fishing hook is disclosed that includes a clip formed of an auxiliary member and a surface of a fish hook. The fish hook includes a biasing mechanism configured to urge the auxiliary member against the fish hook.

### CROSS REFERENCE TO RELATED APPLICATIONS

This application claims the benefit of U.S. Provisional Patent Application No. 62/384,101, filed Sep. 6, 2016, the disclosure of which is incorporated herein by reference.

### TECHNICAL FIELD

This disclosure relates to sport fishing, and more particularly to fishing hooks.

### BACKGROUND

The statements in this section merely provide background information related to the present disclosure and may not constitute prior art.

Fishing hooks are well known throughout the world and human history. Fishing hooks may be directly tied to a fishing line and used with bait or used in conjunction with artificial lures or jigs. A wide variety of fish hooks exists in the art including hooks of different sizes, shapes, and materials depending on the intended purpose of the fish hook. Fish hooks may hold various types of artificial, processed, or dead or live baits, e.g., in bait fishing; to act as the foundation for artificial representations of fish prey, e.g., in fly fishing; or to be attached to or integrated into other devices that represent fish prey, e.g., in lure fishing.

In the case of bait fishing, one must pierce the bait through the hook so that the bait is secured. Baiting therefore requires a fisherman to: (1) touch the bait; and (2) pierce the bait with the hook. Some novice fisherman may be discouraged or unable to handle the hook and bait with sufficient skill to bait the hook. Expert fisherman will recognize that the less bait is touched by the fisherman, the more effective it is in attracting fish. Hence, there is a need for an easier method and fish hook that allows a user to bait the hook without touching the bait or piercing the bait through the hook.

### SUMMARY

A fishing hook is disclosed that includes a clip formed of an auxiliary member and a surface of a fish hook. The fish hook includes a biasing mechanism configured to urge the auxiliary member against the fish hook.

In various embodiments, the biasing mechanism is a spring and is configured to urge an auxiliary member against a surface of the fish hook.

In various embodiments, the auxiliary member has a concave surface configured to draw into a convex surface of the fish hook.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a back perspective view of the FISH HOOK HAVING A CLIP of the present invention, in accordance with the present disclosure;

FIG. 2 is a front perspective view of the invention of FIG. 1, in accordance with the present disclosure;

FIG. 3 is a side view of the invention of FIG. 1, as seen from the right side of FIG. 8, in accordance with the present disclosure;

FIG. 4 is a side view of the invention of FIG. 1, as seen from the left side of FIG. 8, in accordance with the present disclosure;

FIG. 5 is a top plan view in elevation of the invention of FIG. 1, in accordance with the present disclosure;

FIG. 6 is a bottom plan view of the invention of FIG. 1, in accordance with the present disclosure;

FIG. 7 is a back view of the invention of FIG. 1, in accordance with the present disclosure;

FIG. 8 is a front view of the invention of FIG. 1, in accordance with the present disclosure; and

FIG. 9 is an exemplary front perspective view of the invention of FIG. 1 in an open position.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The word “exemplary” is used herein to mean “serving as an example, instance, or illustration.” Any aspect described herein as “exemplary” is not necessarily to be construed as exclusive, preferred or advantageous over other aspects.

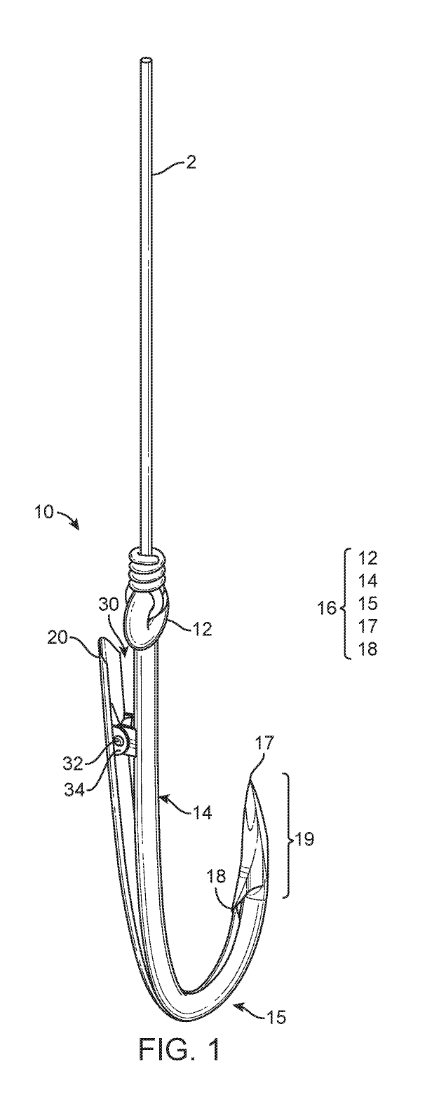

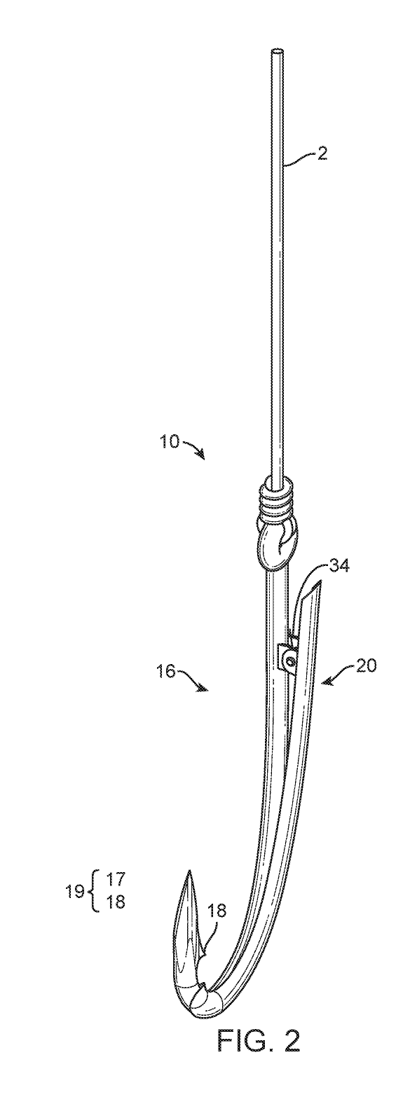

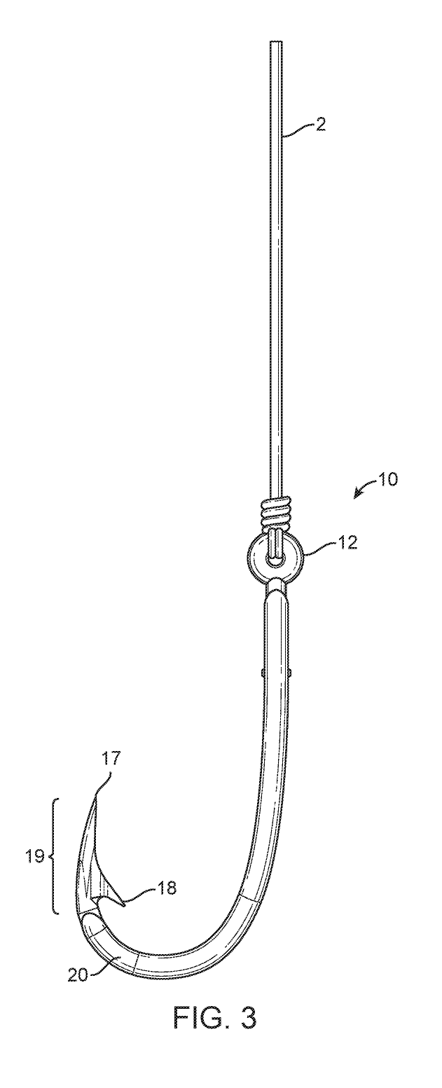

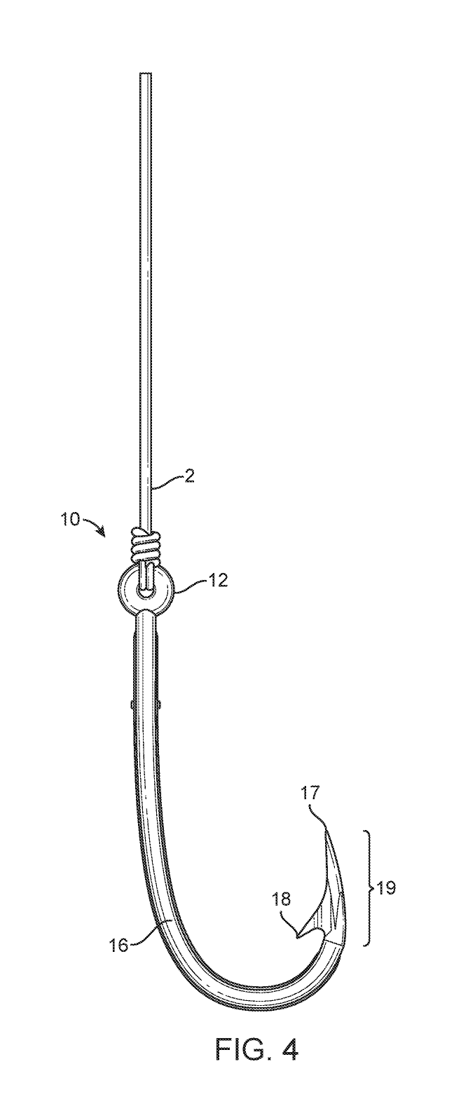

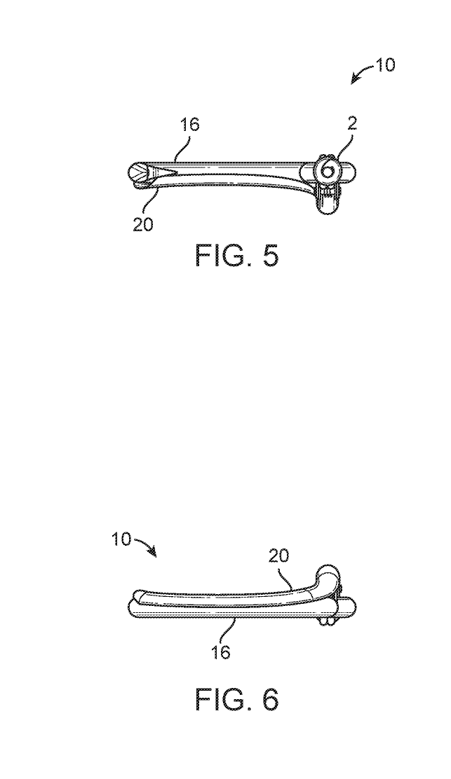

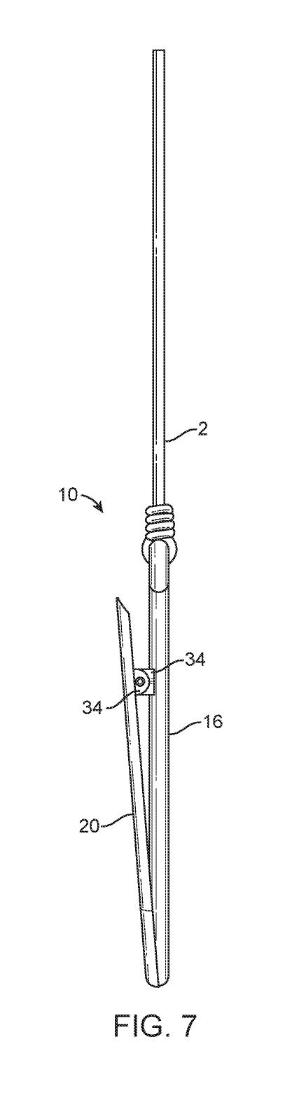

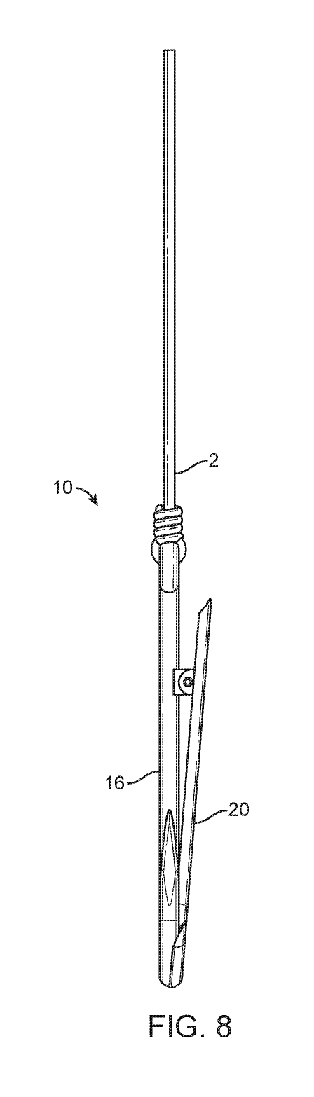

Referring now to the drawings, wherein the depictions are for the purpose of illustrating certain exemplary embodiments only and not for the purpose of limiting the same, FIGS. 1-8 shows an exemplary fish hook clip 10 tied to a fishing line 2. As illustrated in FIGS. 1 through 8, the fish hook clip 10 generally comprises a hook member 16 and a clipping member 20. The hook member 16 and the clipping member 20 are connected via a biased mechanism 30, which may be a spring. The hook member 16 terminates in a point 17 and preferably includes a barb 18, but in some embodiments does not. The hook member 16 includes an eye 12 a shank 14 and a bend 15.

The eye 12 is formed at one end of the hook member 16, preferably configured for attachment to a fishing line 2. Although the fish hook clip 10 is shown with an eye 12 to receive the fishing line 2, the connection between the fish hook clip 10 and the fishing line 2 can be provided by a mechanical connection device, e.g., a socket, an adhesive, or thermos-weld connection to the fishing line.

The shape of the hook shank 14 and the bend 15 can vary from substantially straight to all sorts of curves, kinks, bends and offsets. These different shapes may be applied to different fishing application requirements based upon desired hook penetration, fly imitations or bait holding ability. One skilled in the art will readily appreciate that the teachings herein may be applied to sliced shanks and jig hooks configured or attached to devices intended to lure prey.

The hook member 16, the clipping member 20 and the device 30 may be formed of one or more materials including molded plastic, thermoplastics, steel or other metals. The hook member 16 may have a substantially uniform cross-sectional shape. In various embodiments, the cross-sectional shape is not uniform. A head 19 of the hook member 16 is generally considered to include the point 17 and one or more barbs 18. The head 19 may have a different cross-sectional shape than the shank 14 and the bend 15

In one embodiment, the clipping member 20 is formed to fit flush or near-flush to a surface of the hook member 16. For example, in embodiments where the hook member 16 is round or elliptical-shaped, the clipping member 20 is formed having a concaved surface from which to engage the convexed shape of the hook member 16.

The hook member 16 and the clipping member 20 are attached via the biased mechanism 30, which may be a spring. The biased mechanism 30 may be attached via outwardly projecting members, i.e., protruding members 34. In one embodiment, both the hook member 16 and the clipping member 20 include a pair of protruding members 34. In one embodiment, each pair of protruding members 34 is integrally coupled to one of the members 16 and 20. In one embodiment, the protruding members 34 are perpendicular from a surface thereof and spaced apart from one another. The protruding members 34 have an aperture therein for receiving a rod 32. The rod 32 extends through the apertures in each pair of protruding members 34 such that the hook member 16 and the clipping member 20 are pivotally coupled together.

The biased mechanism 30 urges a distal side of the clipping member 20 to a distal side of the hook member 30, the distal side extending down from the protruding members 34. The biased mechanism 30 biases proximal ends of the hook member 16 and the clipping member 20 away from each other. The biased mechanism 30 is preferably wrapped about the rod 34 to form the biased mechanism 30. Each end of the biased mechanism 30 is abutted against one of the hook member 16 and the clipping member 20. Each of the ends of the spring extends toward one of the proximal ends of either the hook member 16 or the clipping member 20.

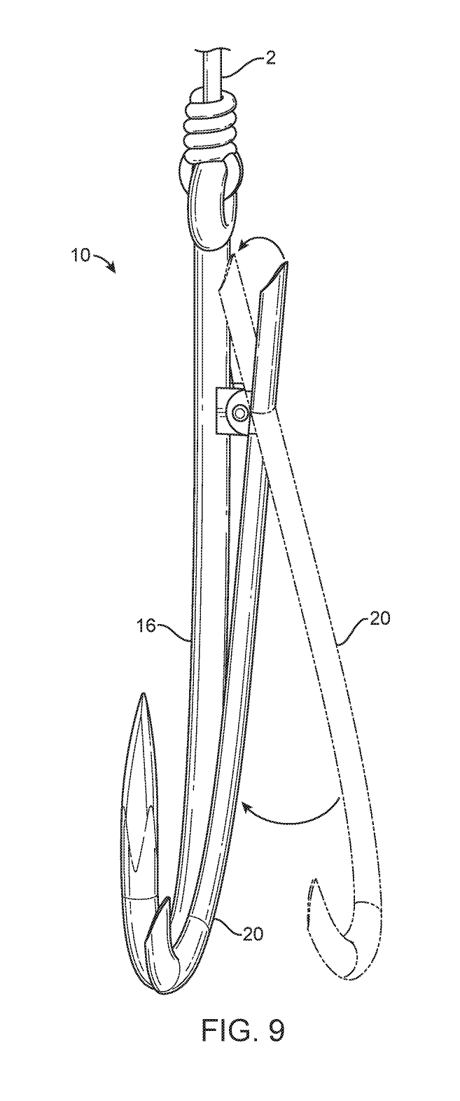

FIG. 9 shows movement of the clipping member 20 relative to the hook member 16. As FIG. 9 shows, the clipping member 20 may be pivoted away from the hook member 16 so that one may insert bait between the clipping member 20 and the hook member 16 and then released to pivot back. In doing so, the clipping member 20 holds the bait against the hook member 16 when the biased member 30 is released from the open position by a fisherman or other user. In this way, the fisherman or user avoids having to pierce the bait into the hook body using the hook head.

With respect to the above description then, it is to be realized that the optimum dimensional relationships for the parts of the invention, to include variations in size, materials, shape, form, function and manner of operation, assembly and use, are deemed readily apparent to one skilled in the art upon a careful reading of the teachings herein, and all equivalent relationships to those illustrated in the drawings and described in the specification are intended to be encompassed by the present invention.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. A fishing hook comprising:
a hook having a body portion and a head portion;
an auxiliary member; and
a biasing mechanism connected to the body portion and the auxiliary member.

2. The fishing hook of claim 1, wherein the auxiliary member is substantially curved.

3. The fishing hook of claim 1, wherein the auxiliary member comprises a concaved interior surface for engaging a convexed exterior surface of the body portion.

4. The fishing hook of claim 1, wherein the biasing mechanism is a spring and is set to press the auxiliary member against an exterior surface of the body portion.

5. The fishing hook of claim 1, wherein the biasing mechanism further comprises:
a spring;
a first pair of protruding members, protruding from the auxiliary member;
a second pair of protruding members, protruding from the body portion; and
a rod extending through apertures on the first and second pair of protruding members.

6. The fishing hook of claim 5, wherein the spring is positioned and configured to exert a force against an underside of a non-clipping side of the auxiliary member, the non-clipping side being above the rod.

7. A fishing hook comprising:
a hook having a body portion and a head portion, the body portion including an eye for attaching a fishing line, a shank portion, and a bend portion, and wherein the head portion comprises a point and a barb;
an auxiliary member pivotally connected to the body portion; and
a biasing mechanism connected to the body portion and the auxiliary member.

8. The fishing hook of claim 8, wherein the auxiliary member is substantially curved.

9. The fishing hook of claim 8, wherein the auxiliary member comprises a concaved interior surface for engaging a convexed exterior surface of the body portion.

10. The fishing hook of claim 8, wherein the biasing mechanism is a spring and is set to press the auxiliary member against an exterior surface of the body portion.

11. The fishing hook of claim 8, wherein the biasing mechanism further comprises:
a spring;
a first pair of protruding members, protruding from the auxiliary member;
a second pair of protruding members, protruding from the body portion; and
a rod extending through apertures on the first and second pair of protruding members.

12. The fishing hook of claim 11, wherein the spring is positioned and configured to exert a force against an underside of a non-clipping side of the auxiliary member, the non-clipping side being above the rod.

13. A fishing hook comprising:
a hook having a body portion and a head portion, the body portion having a substantially uniform cross-sectional shape and including an eye for attaching a fishing line, a shank portion, and a bend portion, and wherein the head portion comprises a point and a barb;
an auxiliary member; and
a biasing mechanism connected to the body portion and the auxiliary member.

14. The fishing hook of claim 13, wherein the auxiliary member is substantially curved.

15. The fishing hook of claim 14, wherein the auxiliary member comprises a concaved interior surface for engaging a convexed exterior surface of the body portion.

16. The fishing hook of claim 13, wherein the biasing mechanism is a spring and is set to press the auxiliary member against an exterior surface of the body portion.

17. The fishing hook of claim 15, wherein the biasing mechanism further comprises:
a spring;
a first pair of protruding members, protruding from the auxiliary member;
a second pair of protruding members, protruding from the body portion; and
a rod extending through apertures on the first and second pair of protruding members.

18. The fishing hook of claim 17, wherein the spring is positioned and configured to exert a force against an underside of a non-clipping side of the auxiliary member, the non-clipping side being above the rod.
